(19) United States
(12) Patent Application Publication
(10) Pub. No.: US 2010/0123745 A1
(43) Pub. Date: May 20, 2010

(54) FRAME DATA CREATION DEVICE, CREATION METHOD, CREATION PROGRAM, STORAGE MEDIUM STORING THE PROGRAM, AND IMAGING DEVICE

(75) Inventors: Daisuke Nakaya, Kanagawa (JP); Takayuki Uemura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/993,050

(22) PCT Filed: Jun. 21, 2006
(86) PCT No.: PCT/JP2006/312397

§ 371 Date: Dec. 19, 2007

(30) Foreign Application Priority Data
Jun. 23, 2005 (JP) 2005-183901

(51) Int. Cl. B41J 29/38

(52) U.S. Cl. 347/9

(57) ABSTRACT

A spatial light modulation element having a plurality of plotting element groups is moved in a scan direction and frame data is inputted into the spatial light modulation element according to the movement so as to form an image. A device creates the frame data used here. When the frame data is created according to image data having pixel data arranged in two-dimensional way in the sub-scan direction corresponding to the scan direction and the main scan direction orthogonally intersecting the sub-scan direction, each of the positions of the plotting points obtained by at least some plotting elements of the plotting element group (circles 1 to 24) is detected and the frame data is created according to the position of each of the plotting points detected.

### TECHNICAL FIELD

The invention relates to a frame data creation device, creation method, creation program, a storage medium storing the program, for creating frame data used for forming an image by moving a imaging dot formation unit, such as a spatial light modulator, with respect to a imaging surface in a predetermined scanning direction, and a imaging device for performing imaging using the frame data created using the frame data creation device.

### BACKGROUND ART

In recent years, there has been developed a multi-beam exposure device which uses a spatial light modulator such as a digital micro mirror device (DMD) as a pattern generator to perform image exposure on an exposing member by an optical beam modulated according to image data.

A DMD is a mirror device having a large number of micro mirrors each of which changes an angle of reflection planes respectively according to a control signal, arrayed on a semiconductor substrate such as silicon in a two-dimensional manner and the each of the micro mirrors changes the angle of the reflection planes by static electricity force of electric charge stored in each memory cell.

In a conventional multi-beam exposure device using the DMD, for example, a laser beam emitted from a light source emitting the laser beam is collimated by a lens system. The device uses an exposure head which reflects the laser beams on a plurality of micro mirrors of the DMD arranged substantially at the focal position of the lens system and emits the beams from a plurality of beam emission windows. Further, the beams emitted from the beam emission windows of the exposure head are focused on an exposure surface of a photosensitive material (exposing member) by a lens system which has an optical element, such as a micro lens array, focusing the beams for each pixel by one lens, so as to reduce their spot diameter, thereby performs an image exposure with high resolution.

In such exposure device, on and off of each of the micro mirrors of the DMD is controlled by a control unit based on a control signal generated according to image data to modulate (deflect) the laser beam, and then, the modulated laser beam is emitted onto the exposure surface (recording surface) for exposure.

In the exposure device, the photosensitive material (such as photoresist) is arranged on the recording surface, and the laser beams are emitted onto the photosensitive material from plural exposure heads of the multi-beam exposure device. Thus, the device is configured to enable a pattern exposure processing on the photosensitive material by modulating each of the DMDs according to the image data, while moving the position of the focused beam spot with respect to the photosensitive material.

When such exposure device is used for a processing for exposing a circuit pattern on a substrate in high accuracy, an origin is set at a predetermined position of an entire surface exposure area projected on the imaging surface. Based on this origin, a relative position (exposure point) of an optical image obtained by a predetermined micro mirror is measured by a dedicated device before imaging, and the actual measurement value is stored in a ROM of a system control circuit as exposure point coordinate data. When the imaging is performed, the actual measurement value is outputted as the exposure point coordinate data to an exposure point coordinate data memory. Thus, the exposure data memory holds bit data of the circuit pattern substantially including a lens magnification error and a mounting error of the exposure head. Therefore, the exposure data given to each of the micro mirrors is a value considering these errors. Thus, even if the optical element of the exposure unit has an error, the circuit pattern may be plotted at high accuracy (for instance, see Patent Document 1).

### Patent Document 1: Japanese Patent Application Laid-Open (JP-A) No. 2003-57836

### DISCLOSURE OF THE INVENTION

### Problems to be Solved by the Invention

However, when such multi-beam exposure device performs imaging at high accuracy, the imaging position of the exposure head will be changed with time due to temperature, vibration, and the like. Therefore, an amount of deviation of each imaging position changed with time needs to be measured by the dedicated device each time before the imaging to be appropriately corrected.

In view of the above problems, the invention provides a frame data creation device, method, program, and storage medium storing the program, which can correct the deviation of the imaging position due to change with time, and a imaging device using the above frame data creation device.

### Means for Solving the Problems

A first aspect of the present invention is a frame data creation device that creates frame data used for forming an image having a plurality of imaging dots arranged two-dimensionally on an imaging surface, in which the image is formed by moving, with respect to the imaging surface, an imaging dot formation unit having a plurality of imaging element groups arrayed in parallel, in a scanning direction forming a predetermined angle of θ (0°<θ<90°) with an array direction of the imaging element group, and by sequentially inputting the frame data including data of the plurality of imaging dots corresponding to the imaging elements into the imaging dot formation unit during the movement in the scanning direction to sequentially form an imaging dot group in chronological order, wherein the imaging element group includes a plurality of imaging elements, which form the imaging dots on the imaging surface, arranged in a line, and the frame data creation device obtains the plurality of imaging dots data based on image data according to the image in which pixel data corresponding to the imaging dots data is arranged two-dimensionally in a sub-scanning direction corresponding to the scanning direction and a main scanning direction that is orthogonal to the sub-scanning direction, so as to create the frame data, the frame data creation device including: an imaging dot position detection unit that detects each of the positions of the imaging dots to be formed by at least some of the imaging elements of the imaging element group; and a frame data creation unit that creates the frame data so as to correct a deviation of the pixel position due to a deviation of the position of the imaging dot, based on the detected position of each of the imaging dots.

According to the above invention, each of the positions of the imaging dots to be formed by at least some of the imaging elements of the imaging element group is detected, and the frame data is created based on the detected position of each of the imaging dots. Therefore, even when the position of the imaging dot to be formed by the imaging element changes with time due to temperature and so on, it may automatically correct the deviation of the pixel position due to the deviation of the position of the imaging dot. Further, a complicated mechanism for adjusting the deviation of the imaging position of the imaging element group is unnecessary, so that the frame data creation device can be configured at low cost.

The above-described “angle” refers to a smaller angle of angles formed between the array direction of the imaging element group and the scanning direction.

The frame data creation device in this aspect may further include a calculation unit that calculates at least one of an optical magnification of the imaging element group in a predetermined direction, a tilt thereof, or an amount of movement from a predetermined reference position, based on the detected position of each of the imaging dots, wherein the frame data creation unit creates the frame data so as to correct a deviation of the pixel position due to a deviation of the position of the imaging dot, based on the calculation value of the calculation unit.

The calculation unit may calculate a resolution in the main scanning direction, and the frame data creation unit may convert the image data according to the resolution and create the frame data based on the converted image data.

According to this configuration, the deviation of the pixel position in the main scanning direction due to the deviation of the imaging position caused by errors of the optical magnification in the main scanning direction can be corrected.

In this case, preferably, the frame data creation unit may convert the image data so as to have a resolution of an integral multiple of the resolution.

The frame data creation device may further include an image data transformation unit that performs a transformation processing to the image data according to the tilt of the imaging element group so that the pixel data in the image data corresponding to the imaging element group are arrayed in the main scanning direction, wherein the frame data creation unit obtains the plurality of imaging dots data based on the transformed image data to create the frame data.

In this case, preferably, the frame data creation device may further include a storage unit that stores the transformed image data; and a storage controller that stores the pixel data in a manner such that an array direction of the pixel data corresponding to the imaging element group matches with a direction in which addresses of the storage unit are continuous, wherein the frame data creation unit reads the pixel data stored in the storage unit from the storage unit to obtain the plurality of imaging dots data.

Here, the “direction in which addresses are continuous” refers to a direction that addresses in a storage space, that a controller, such as a CPU, controlling storing and reading of the pixel data in the storage unit recognizes, are continuous. Thereby the imaging dot data can be obtained at high speed.

The image data transformation unit may perform the transformation processing by shifting each of the pixel data corresponding to the imaging element group in the sub-scanning direction according to the calculation value.

The frame data creation device may further include a pixel data rearrangement unit that rearranges the pixel data in the scanning direction in a manner such that the pixel data belonging to the same frame data corresponding to each of the imaging elements of the imaging element group is arranged successively in the main scanning direction, wherein the frame data creation unit creates the frame data based on the image data rearranged by the pixel data rearrangement unit so as to correct a deviation of the pixel position due to a deviation of the position of the imaging dot in the scanning direction based on the calculation value.

According to this configuration, the deviation of the pixel position in the scanning direction due to the deviation of the imaging position caused by the errors of the optical magnification in the scanning direction can be corrected.

The imaging element may include a micro mirror, and the imaging dot formation unit may include an exposure unit that exposes an imaging image onto an exposure surface by modulating light emitted from a light source by the micro mirror.

The invention may be also realized as a method corresponding to the operation of the frame data creation device, a program executing the corresponding processing, and a storage medium storing the program.

A second aspect of the invention is a frame data creation method that creates frame data used for forming an image having a plurality of imaging dots arranged two-dimensionally on an imaging surface, in which the image is formed by moving, with respect to the imaging surface, an imaging dot formation unit having a plurality of imaging element groups arrayed in parallel, in a scanning direction forming a predetermined angle of θ (0°<θ<90°) with an array direction of the imaging element group, and by sequentially inputting the frame data including data of a plurality of imaging dots corresponding to the imaging elements into the imaging dot formation unit according to the movement in the scanning direction to sequentially form the imaging dot group in chronological order, wherein the imaging element group includes a plurality of imaging elements, which form the imaging dots on the imaging surface arranged in a line, and the method obtains the plurality of imaging dots data based on image data according to the image in which pixel data corresponding to the imaging dot data is arranged two-dimensionally in a sub-scanning direction corresponding to the scanning direction and a main scanning direction orthogonal to the sub-scanning direction, so as to create the frame data, the frame data creation method including: detecting each of positions of the imaging dots to be formed by at least some of the imaging elements of the imaging element group; and creating the frame data so as to correct a deviation of the pixel position due to a deviation of the position of the imaging dot based on the position of each of the detected imaging dots.

According to this invention, even if the position of the imaging dot formed by the imaging element changes with time due to temperature and so on, it may correct the deviation of the pixel position due to the deviation of the position of the imaging dot.

A third aspect of the invention is a frame data creation program that performs in a computer a procedure for creating frame data used for forming an image having a plurality of imaging dots arranged two-dimensionally on an imaging surface, in which the image is formed by moving, with respect to the imaging surface, an imaging dot formation unit having a plurality of imaging element groups arrayed in parallel, in a scanning direction forming a predetermined angle of θ (0°<θ<90°) with an array direction of the imaging element group, and by sequentially inputting the frame data including data of a plurality of imaging dots corresponding to the imaging elements into the imaging dot formation unit during the movement in the scanning direction to sequentially forming the imaging dot group in chronological order, wherein the imaging element group includes a plurality of imaging elements, which form the imaging dots on the imaging surface, arranged in a line, and the program causes the computer to perform a processing to obtain the plurality of imaging dot data based on image data according to the image in which pixel data corresponding to the imaging dot data is arranged two-dimensionally in a sub-scanning direction corresponding to the scanning direction and a main scanning direction that is orthogonal to the sub-scanning direction, so as to create the frame data, the processing including: detecting each of the positions of the imaging dots to be formed by at least some imaging elements of the imaging element group; and creating the frame data so as to correct a deviation of the pixel position due to a deviation of the position of the imaging dot based on the position of each of the detected imaging dots.

A fourth aspect of the invention is a storage medium that stores a frame data creation program that performs in a computer a procedure for creating frame data used for forming an image having a plurality of imaging dots arranged two-dimensionally on an imaging surface, in which the image is formed by moving, with respect to the imaging surface, an imaging dot formation unit having a plurality of imaging element groups arrayed in parallel, in a scanning direction forming a predetermined angle of θ (0°<θ<90°) with an array direction of the imaging element group, and by sequentially inputting the frame data including data of a plurality of imaging dots corresponding to the imaging elements into the imaging dot formation unit during the movement in the scanning direction to sequentially form the imaging dot group in chronological order, wherein the imaging element group includes a plurality of imaging elements forming the imaging dots on the imaging surface arranged in a line, and the frame data creation program causes the computer to perform a processing to obtain the plurality of imaging dot data based on image data according to the image in which pixel data corresponding to the imaging dot data is arranged two-dimensionally in a sub-scanning direction corresponding to the scanning direction and a main scanning direction orthogonal to the sub-scanning direction so as to create the frame data, the processing including: detecting each of the positions of the imaging dots to be formed by at least some imaging elements of the imaging element group; and creating the frame data so as to correct a deviation of the pixel position due to a deviation of the position of the imaging dot based on the position of each of the detected imaging dots.

According to this invention, even if the position of the imaging dot to be formed by the imaging element changes with time due to temperature and so on, it may correct the deviation of the pixel position due to the deviation of the position of the imaging dot.

A fifth aspect of the invention is an image imaging device including: a frame data creation device of the first aspect; the imaging dot formation unit that forms the imaging dot group having the plurality of imaging dots on the imaging surface based on the inputted frame data; a movement unit that moves the imaging dot formation unit with respect to the imaging surface in the scanning direction; and an image formation controller that sequentially inputs the frame data created by the frame data creation device into the imaging dot formation unit during the movement by the movement unit in the scanning direction to sequentially form the imaging dot group by the imaging dot formation unit in chronological order, and forming an image having the plurality of imaging dots arranged two-dimensionally on the imaging surface.

According to this invention, even of the position of the imaging dot to be formed by the imaging element changes with time due to temperature and so on, it may correct the deviation of the pixel position due to the deviation of the position of the imaging dot.

### EFFECT OF THE INVENTION

According to the exposure device of the present invention, when performing an exposure by the beam emitted from a side of a unit for selectively modulating a plurality of pixels, an amount of deviation of an imaging position changed with time due to temperature and vibration can be detected, as needed. Therefore, there is an effect that the deviation of the pixel position may be appropriately corrected corresponding to the detected amount of deviation of the imaging position, and thereby an imaging can be performed at higher accuracy and an exposure image of high quality as be obtained.

### BRIEF DESCRIPTION OF THE DRAWINGS

FIG. 1 is an overall schematic perspective view of an image forming device according to an embodiment of a multi-beam exposure device of the present invention.

FIG. 2 is a schematic perspective view of a main portion showing a state of exposing a photosensitive material by exposure heads of an exposure head unit provided in the image forming device according to the embodiment of the invention.

FIG. 3 is an enlarged schematic perspective view of the main portion showing the state of exposing the photosensitive material by one exposure head of the exposure head unit provided in the image forming device according to the embodiment of the invention.

FIG. 4 is a schematic block diagram of an optical system for the exposure head of the image forming device according to the embodiment of the invention.

FIG. 5A is a plan view of a main portion showing scan trajectories of reflection light images (exposure beams) obtained by micro mirrors in the image forming device according to the embodiment of the invention when a DMD is not tilted.

FIG. 5B is a plan view of the main portion showing scan trajectories of the exposure beams in the image forming device according to the embodiment of the invention when the DMD is tilted.

FIG. 6 is an enlarged perspective view of a main portion showing a configuration of the DMD used for an exposure device according to the embodiment of the invention.

FIG. 7A is an explanatory view for explaining an operation of the DMD used for the exposure device according to the embodiment of the invention.

FIG. 7B is an explanatory view for explaining the operation of the DMD used for the exposure device according to the embodiment of the invention.

FIG. 8 is an explanatory view showing a state of detecting a predetermined number of plural particular pixels, which are lighted, by using a plurality of slits for detection according to the image forming device according to the embodiment of the invention.

FIG. 9 is an explanatory view showing an example of the relative position relation between the plurality of slits for detection formed in a slit plate according to the image forming device according to the embodiment of the invention.

FIGS. 10A and 10B are explanatory views, in which FIG. 10A shows a state of detecting the position of the lighted particular pixel using the slits for detection according to the image forming device according to the embodiment of the invention, and FIG. 10B shows signals when the lighted particular pixel is detected by a photosensor.

FIG. 11 is a block diagram showing an electric configuration of the exposure device shown in FIG. 1.

FIG. 12 is a diagram showing a correspondence relation between each pixel data of image data and each of the micro mirrors into which the pixel data is inputted.

FIG. 13 is a diagram showing an example of transformed image data.

FIG. 14 is a diagram showing an example of rearrangement-processed image data.

FIG. 15 is a diagram showing frame data created in the exposure device shown in FIG. 1.

FIG. 16 is a diagram showing a correspondence relation between each pixel data of image data and each of the micro mirrors into which the pixel data is inputted, when magnification deviation occurs.

FIG. 17 is a diagram showing an example of rearrangement-processed image data when the magnification deviation occurs.

### BEST MODES FOR CARRYING OUT THE INVENTION

An embodiment of a multi-beam exposure device of the invention will be described with reference to the drawings.

### [Configuration of Image Forming Device]

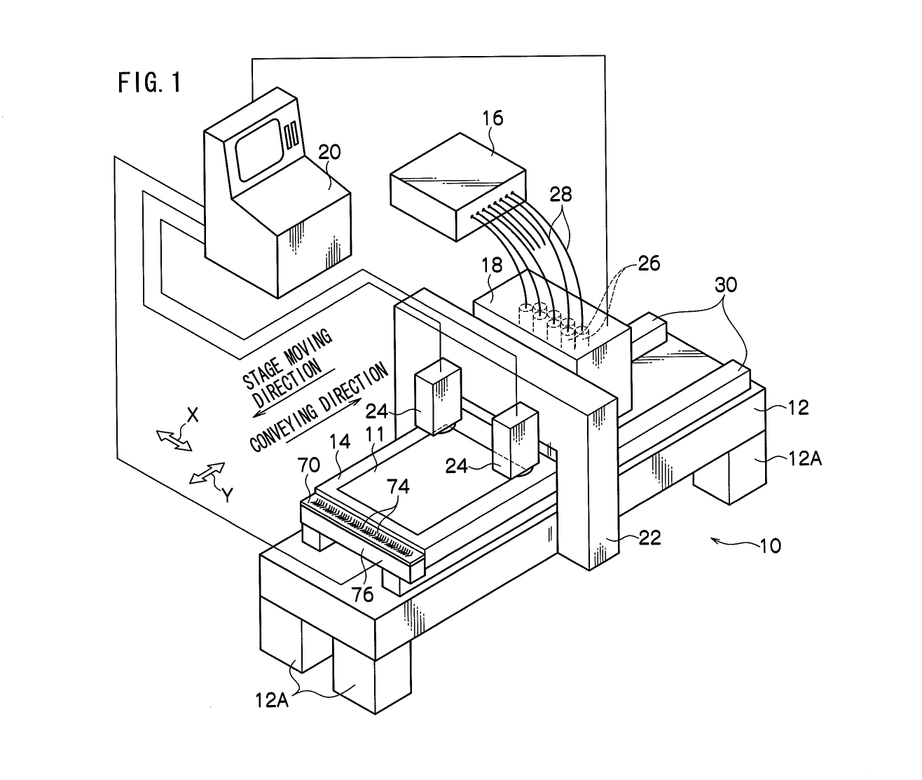

As shown in FIG. 1, an exposure device 10 configured as a multi-beam exposure device according to the embodiment of the invention is a so-called flat bed type. The exposure device 10 mainly includes a base table 12 supported by four leg members 12A, a moving stage 14, a light source unit 16, an exposure head unit 18, and a controller 20. The moving stage 14 is provided on the base table 12 and capable of moving in the Y direction in the drawing. The moving stage 14 moves with mounting a photosensitive material which is formed on the surface of a glass substrate, such as a printed circuit board (PCB), a color liquid crystal display (LCD), and a plasma display panel (PDP) fixed thereon. The light source unit 16 emits as a laser beam a multi-beam including an ultraviolet wavelength region and extended in one direction. The exposure head unit 18 spatially modulates the multi-beam from the light source unit 16 according to the position of the multi-beam based on desired image data, and irradiates the modulated multi-beam as an exposure beam onto the photosensitive material having sensitivity in a wavelength region of the multi-beam. The controller 20 generates from the image data a modulation signal fed to the exposure head unit 18 during the movement of the moving stage 14.

In the exposure device 10, the exposure head unit 18 for exposing the photosensitive material is arranged above the moving stage 14. The exposure head unit 18 is provided with a plurality of exposure heads 26. The exposure heads 26 are respectively connected to a bundle-like optical fiber 28 drawn from the light source unit 16.

In the exposure device 10, a gate 22 is provided so as to straddle the base table 12. A pair of position detection sensors 24 is mounted on both surfaces of the gate 22. The position detection sensor 24 feeds to the controller 20 a detection signal when detecting passage of the moving stage 14.

In the exposure device 10, two guides 30 extended in a stage moving direction are provided on the upper surface of the base table 12. The moving stage 14 is mounted on the two guides 30 so as to be reciprocated. The moving stage 14 is moved by a linear motor (not shown) at a relatively low, constant speed such as 40 mm/sec while an amount of the movement is 1000 mm.

The exposure device 10, perform scanning and exposure while moving the photosensitive material (substrate) placed on the moving stage 14 with respect to the fixed exposure head unit 18.

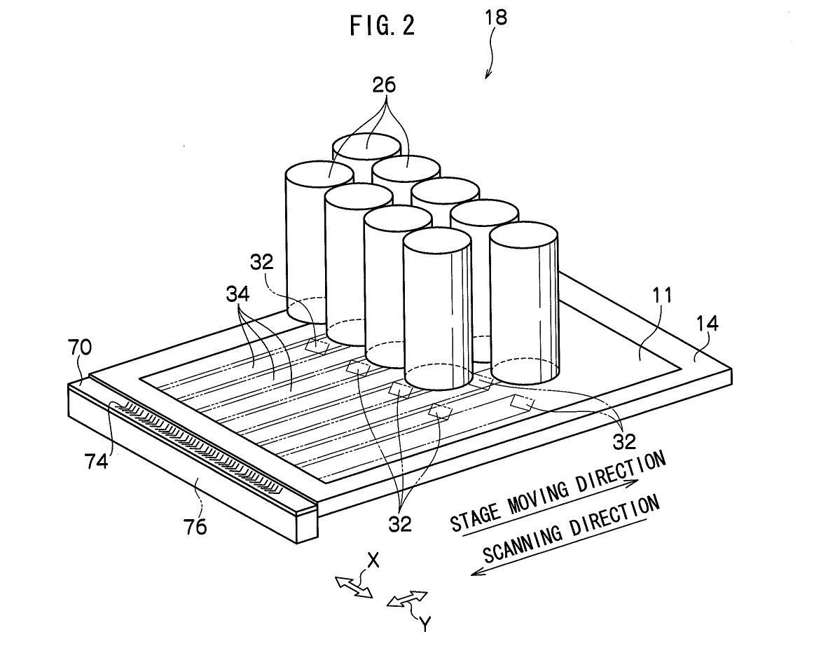

As shown in FIG. 2, a plurality of exposure heads 26 arrayed in a substantial matrix of m rows and n columns are provided in the exposure head unit 18. In FIG. 2, nine exposure heads 26 are provided in a manner such that 5 columns of the exposure heads 26 are arrayed in the first row and 4 columns of the exposure heads 26 are arrayed in the second row.

An exposure area 32 of the exposure head 26 is configured to have a rectangular shape having a short side in a scanning direction. In this case, a band-shaped exposed area 34 is formed on a photosensitive material 11 for each of the exposure heads 26 following the moving operation for the scanning and exposure.

As shown in FIG. 2, each of the exposure heads 26 in each row arrayed in a line is arranged so as to be offset by a predetermined interval (natural number times the long side of the exposure area) in an array direction, so that the band-shaped exposed area 34 is arrayed in a direction orthogonal to the scanning direction without a space. Therefore, an unexposed portion between the exposure area 32 in the first column and the exposure area 32 in the second column may be exposed by the exposure area 32 in the second row.

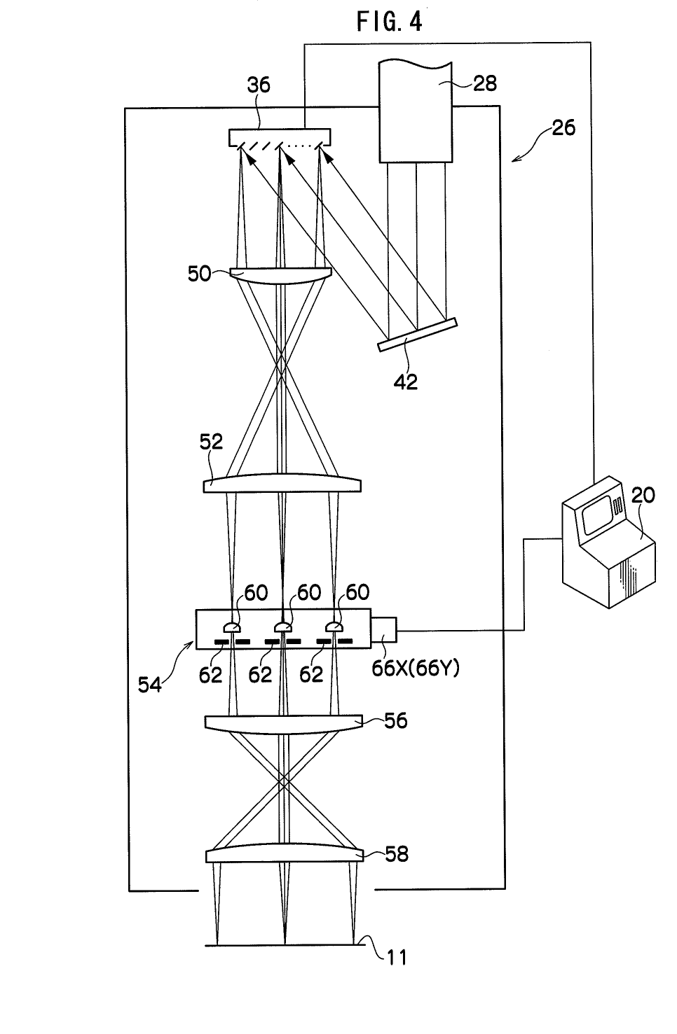

As shown in FIG. 4, each of the exposure heads 26 includes a digital micro mirror device (DMD) 36 as a spatial light modulator for modulating each incident optical beam for each pixel according to image data. The DMD 36 is connected to the controller 20.

The controller 20 generates a control signal for driving and controlling for each of the exposure heads 26 respective micro mirrors in an area to be controlled in the DMD 36 based on the inputted image data. Although the detail will be described later, the controller 20 performs processing to create frame data for driving and controlling the DMD 36 by detecting the position of each exposure point exposed by the exposure head 26, and transforming and/or rearranging the inputted image data based on the detected position of the exposure point.

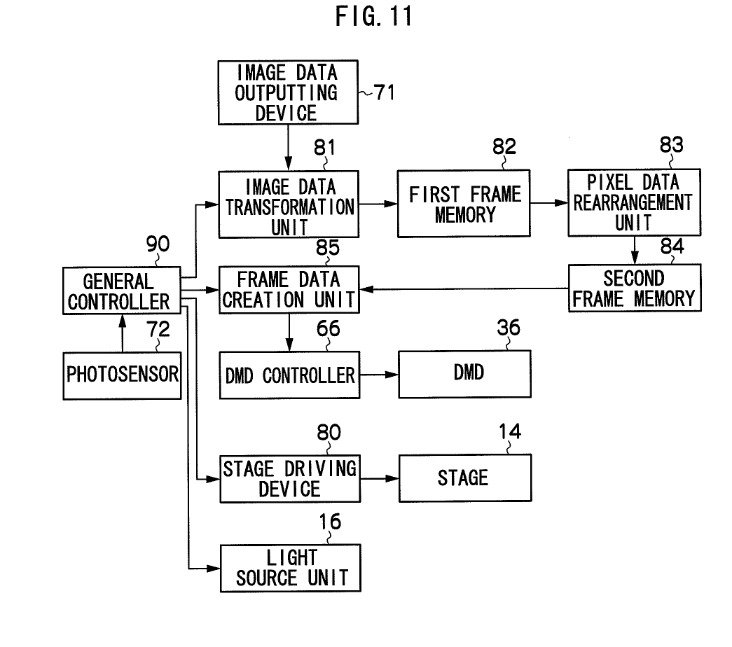

The controller 20 includes a DMD controller 66 (see FIG. 11). The DMD controller 66 controls an angle of the reflection plane of each of the micro mirrors in the DMD 36 for each of the exposure heads 26 based on the created frame data. The control of the angle of the reflection plane will be described later.

As shown in FIG. 1, the light incident side of the DMD 36 of each of the exposure heads 26 is connected to the bundle-like optical fiber 28 drawn from the light source unit 16 which is a lighting device for emitting as a laser beam a multi-beam including an ultraviolet wavelength region and extending in one direction.

Although not shown, the light source unit 16 includes, in its inside, a plurality of multiplexing modules which multiplex the laser beam emitted from plural semiconductor laser chips and input it into an optical fiber. The optical fiber extended from each of the multiplexing modules is a multiplexing optical fiber for propagating a multiplexed laser beam. A plurality of the optical fibers is bundled to form the bundle-like optical fiber 28.

As shown in FIG. 4, a mirror 42 for reflecting the laser beam emitted from a connection terminal of the bundle-like optical fiber 28 toward the DMD 36 is arranged at the light incidence side of the DMD 36 of each of the exposure heads 26.

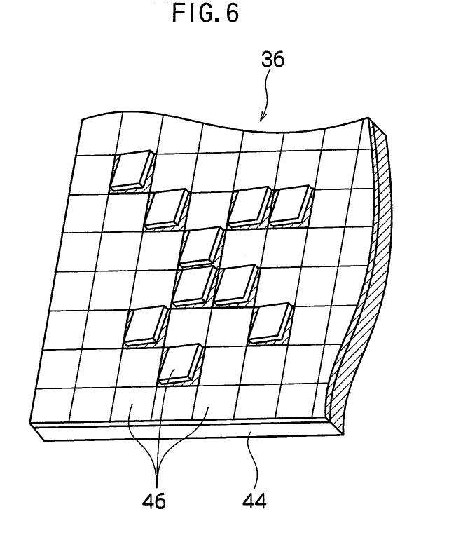

As shown in FIG. 6, the DMD 36 is formed such that micro mirrors 46 are respectively supported by a support and arranged on an SRAM cell (storage cell) 44. The DMD 36 is configured as a mirror device having a large number (e.g., 600×800) of the micro mirrors structuring pixels arrayed in a grid shape. Each of the pixels has, in its topmost portion, the micro mirror 46 supported by the support. A material having a high reflectivity, such as aluminum, is deposited on the surface of the micro mirror 46.

The SRAM cell 44 of a CMOS of a silicon gate manufactured on a typical semiconductor storage manufacturing line is arranged just below the micro mirror 46 via the support including a hinge and a yoke, which are not shown, and these components are entirely configured to be monolithic (integrated).

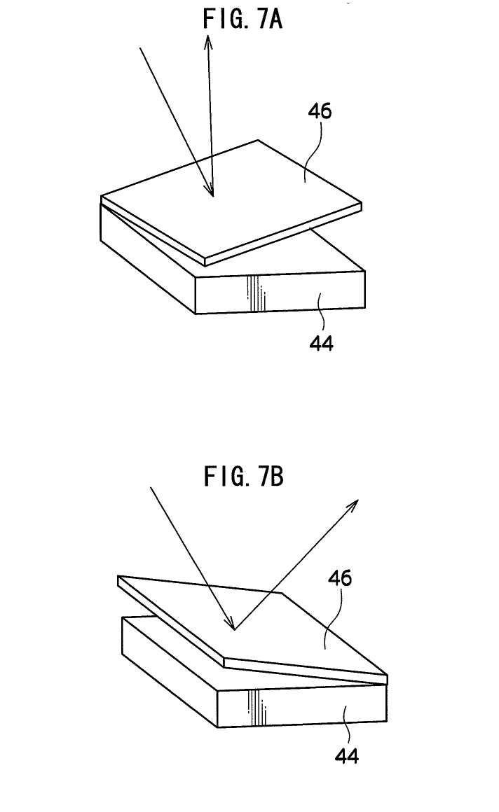

When a digital signal is written into the SRAM cell 44 of the DMD 36, the micro mirror 46 supported by the support is tilted around a diagonal line of the micro mirror 46 in a range of ±a° (e.g., ±10°) with respect to the side of a substrate in which the DMD 36 is arranged. FIG. 7A shows a state that the micro mirror 46 is tilted at +a°, which is in on state. FIG. 7B shows a state that the micro mirror 46 is tilted at −a°, which is in off state. Thus, by controlling the tilt of the micro mirror 46 of each of the pixels of the DMD 36 according to an image signal, as shown in FIG. 6, the light incident to the DMD 36 is reflected in the tilted direction of each of the micro mirrors 46.

FIG. 6 shows enlarged part of the DMD 36 and an example of a state that the micro mirror 46 is controlled to be the angle of +a° or −a°. The control of on/off of each of the micro mirrors 46 is performed by the controller 20 connected to the DMD 36. The light reflected by the micro mirror 46 in the on state is modulated to be an exposure state and incident to a projection optical system (see FIG. 4) provided at the light emission side of the DMD 36. The light reflected on the micro mirror 46 in the off state is modulated to be a non-exposure state and incident to an optical absorber (not shown).

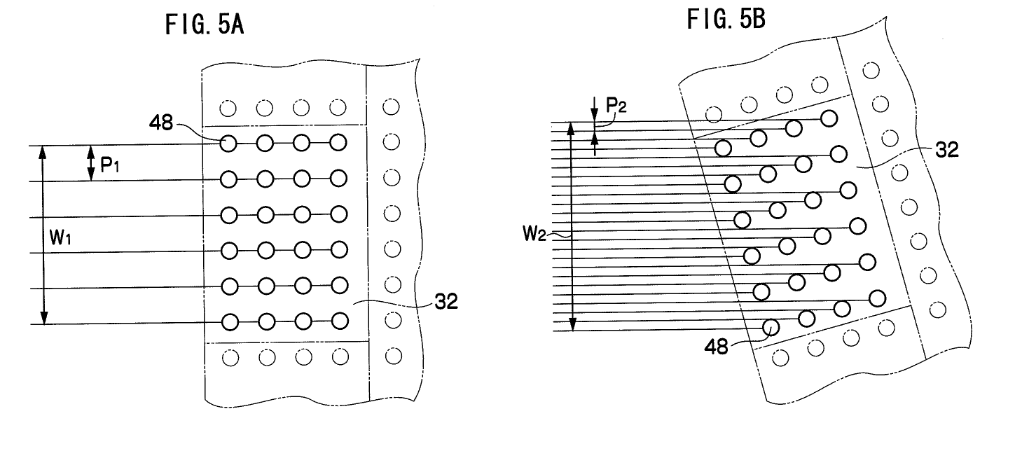

It is Preferable to arrange the DMD 36 so that the short side thereof is slightly tilted in a direction that forms a predetermined angle (e.g., 0.1° to 0.5°) with the scanning direction. FIG. 5A shows scan trajectories of reflected light figures (the exposure beams) 48 of the micro mirrors when the DMD 36 is not tilted. FIG. 5B shows scan trajectories of the exposure beams 48 when the DMD 36 is tilted.

In the DMD 36, a large number of sets (e.g., 600 sets) of micro mirror rows having a large number (e.g., 800) of micro mirrors 46 arrayed in a longitudinal direction (row direction) of the DMD 36 are arranged in a column direction. As shown in FIG. 5B, a pitch P2 between the scan trajectories (scan lines) of the exposure beams 48 by the micro mirrors 46 when the DMD 36 is tilted is smaller than a pitch P1 between the scan lines when the DMD 36 is not tilted. This may greatly improve a resolution. Since the tilted angle of the DMD 36 is very small, a scan width W2 when the DMD 36 is tilted is substantially equal to a scan width W1 when the DMD 36 is not tilted.

Further, substantially same positions (dots) on the same scan line are exposed again (multi-exposed) by different micro mirror lines. By performing this multi-exposing, a small amount of the exposure position can be controlled for realizing high-resolution exposure. Further, jointing portions of the exposure area of the plurality of exposure heads arrayed in the scanning direction can be joined without a step by controlling a very small amount of the exposure position.

Instead of tilting the DMD 36, the same effect can be obtained by arranging each of the micro mirror lines in a staggered manner so that the micro mirror lines are shifted by a predetermined interval with respect to each other in the direction orthogonal to the scanning direction.

Next, the projection optical system (focusing optical system) provided at the light reflection side of the DMD 36 of the exposure head 26 will be described. As shown in FIG. 4, the projection optical system provided at the light reflection side of the DMD 36 of each of the exposure heads 26 projects a light source image on the photosensitive material 11 on the exposure surface at the light reflection side of the DMD 36. Therefore, optical members for exposure of lens systems 50 and 52, a micro lens array 54, and objective lens systems 56 and 58 are arranged in this order from the DMD 36 side toward the photosensitive material 11.

Here, the lens systems 50 and 52 are configured to be a magnifying optical system. The lens systems 50 and 52 enlarge an area of the exposure area 32 (shown in FIG. 2) on the photosensitive material 11 by a bundle of optical beams reflected by the DMD 36 to a predetermined size, by enlarging a cross-sectional area of the bundle of optical beams reflected by the DMD 36.

As shown in FIG. 4, the micro lens array 54 is integrally formed with a plurality of micro lenses 60 corresponding one-to-one to the micro mirrors 46 of the DMD 36 that reflects the laser beam emitted from the light source unit 16 via each of the optical fibers 28. Each of the micro lenses 60 is arranged on the optical axis of each of the laser beams passing through the lens systems 50 and 52.

The micro lens array 54 is formed in a rectangular plate shape. An aperture 62 is integrally formed in the micro lens array 54 at a portion where each of the micro lenses 60 is formed. The aperture 62 is configured to be an aperture diaphragm corresponding one-to-one to each of the micro lenses 60.

As shown in FIG. 4, the objective lens systems 56 and 58 are configured to be an equal magnification optical system. The photosensitive material 11 is positioned at the focal position of the objective lens systems 56 and 58 located behind them. Each of the lens systems 50 and 52 and the objective lens systems 56 and 58 in the projection optical system is described as one lens in FIG. 4. However, the invention is not limited to this configuration and a combination of a plurality of lenses (e.g., a convex lens and a concave lens) may be used.

In the exposure device 10 configured as described above includes a detection unit for detecting information on a position of an exposure point, such as an optical magnification of the exposure point in a conveying direction and a direction orthogonal to the conveying direction, which changes with time due to temperature and vibration in the exposure processing by the exposure head 26, the tilting angle of the exposure head 26, and an amount of movement from a reference position of the exposure head 26.

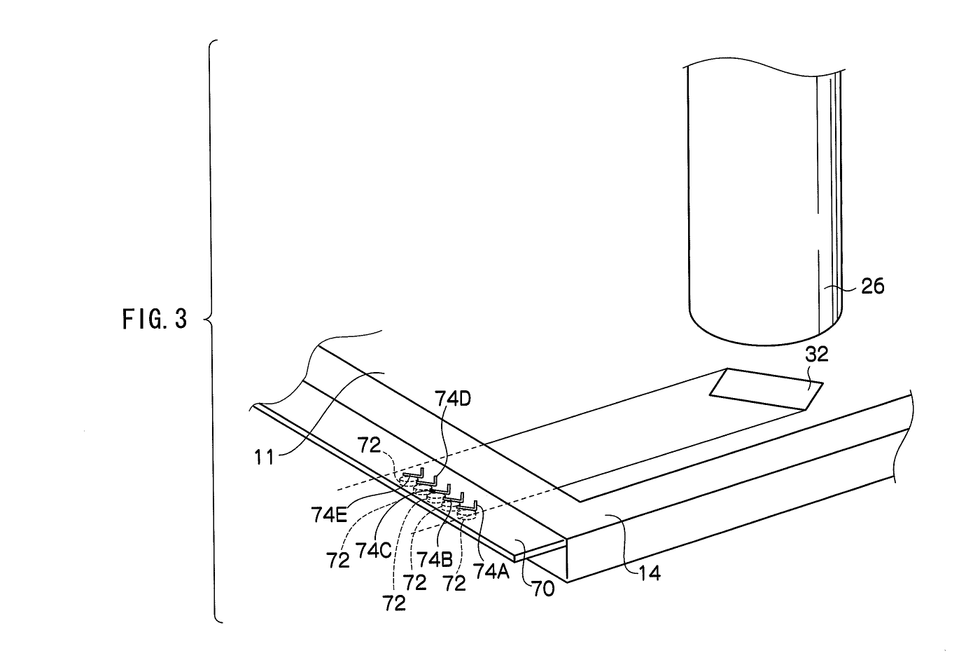

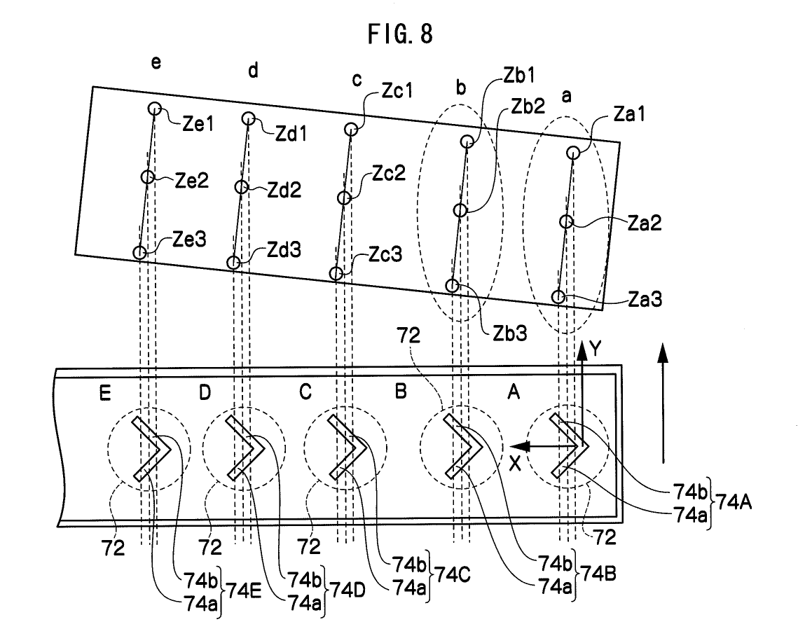

As shown in FIGS. 3 and 8, in the exposure device 10, a beam position detection unit (imaging dot position detection unit) for detecting an emitted beam position is provided, as part of the detection unit, at the upstream side of the moving stage 14 in the conveying direction.

The beam position detection unit includes a slit plate 70 integrally mounted on the edge portion of the moving stage 14 in the upstream side along the conveying direction (scanning direction), and a photosensor 72 as a light sensing unit provided at the back side of the slit plate 70 corresponding to each of slits.

A detection slit is formed in the slit plate 70. The detection slit 74 is formed by forming a thin chrome film for masking (chrome mask or emulsion mask) on a rectangular long plate-shaped silica glass plate having a length of the overall length of the moving stage 14 in a width direction thereof, and removing the chrome film to form a “V” shaped portion opened toward the X axis direction so as to pass the laser beam therethrough in a predetermined plurality of positions of the chrome film by an etching process (for example, a process of masking the chrome film to pattern the slit, and eluting the slit portion of the chrome film by etching liquid).

Thus constructed slit plate 70 made of silica glass is hard to cause an error due to temperature change. Further, since the thin chrome film is used, the beam position can be detected in high accuracy.

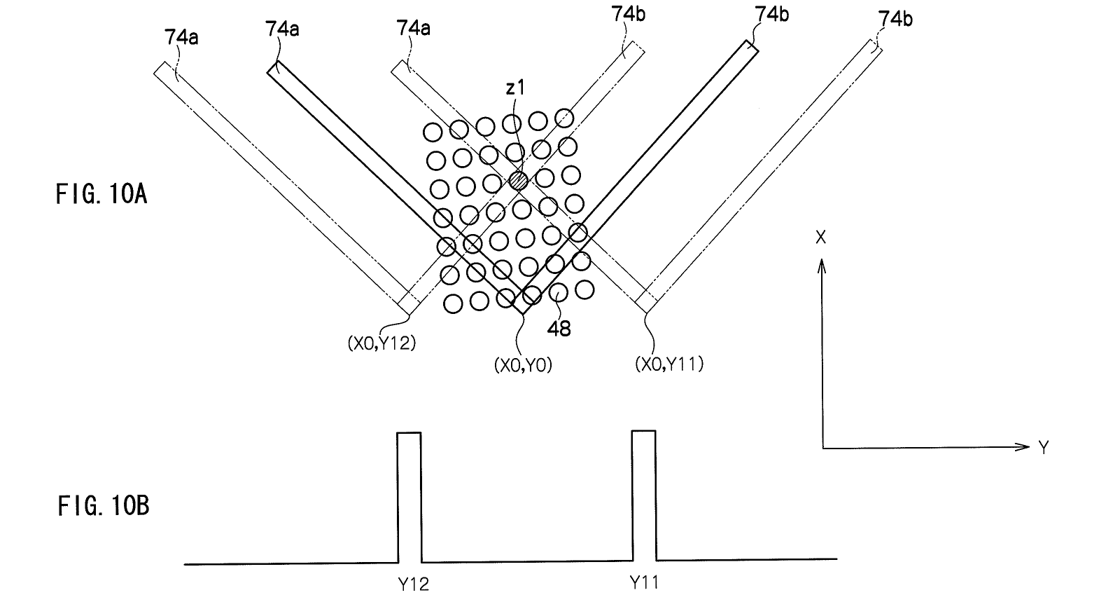

As shown in FIG. 8 and FIG. 10A, the “V” shaped detection slit 74 is formed such that a first linear slit portion 74a having a predetermined length and positioned at the upstream side of the detection slit 74 in the conveying direction and a second linear slit portion 74b having a predetermined length and positioned at the downstream side in the conveying direction of the detection slit 74 are connected at a right angle at respective one end thereof. That is, the first slit portion 74a and the second slit portion 74b orthogonally intersect with each other, and the first slit portion 74a forms an angle of 135° with respect to the Y axis (running direction), and the second slit portion 74b forms an angle of 45° with respect to the Y axis. In this embodiment, the Y axis is set to be the scanning direction and the X axis is set to be the direction orthogonal to the Y axis (the array direction of the exposure head 26).

Here, the first slit portion 74a and the second slit portion 74b in the detection slit 74 are illustrated such that they form an angle of 45° with respect to the scanning direction. However, the angle with respect to the scanning direction may be arbitrarily set in any angle if the first slit portion 74a and the second slit portion 74b are both tilted with respect to the pixel array of the exposure head 26, and also, tilted with respect to the scanning direction, that is, the stage moving direction (i.e., they are arranged so as not to be parallel with the pixel array and the scanning direction). In place of the detection slit 74, a diffraction grating may be used.

The photosensor 72 (such as a CCD, CMOS, or photodetector) for detecting light from the exposure head 26 is arranged in each predetermined position just below the detection slit 74.

Next, the electric configuration of the controller 20 will be described.

As shown in FIG. 11, the controller 20 receives image data outputted from an image data outputting device 71. The controller 20 includes an image data transformation unit 81 for performing transformation processing to the received image data, a first frame memory 82 for temporarily storing the transformed image data transformed by the image data transformation unit 81, a pixel data rearrangement unit 83 for performing rearrangement processing to the transformed image data stored in the first frame memory 82, a second frame memory 84 for temporarily storing the rearrangement-processed image data rearrangement-processed by the image data rearrangement unit 83, a frame data creation unit 85 for creating frame data based on the rearrangement-processed image data stored in the second frame memory 84, a DMD controller 66 for outputting a control signal to the DMD 36 based on the frame data outputted from the frame data creation unit 85, and an general controller 90 for controlling the overall exposure device. The general controller 90 includes a CPU, a memory, and the like.

The image data transformation unit 81, the pixel data rearrangement unit 83, and the frame data creation unit 85 include a memory respectively for storing a program executing a predetermined procedure. The general controller 90 controls the operation of the exposure device according to processing procedures of these programs. The predetermined processing procedures executed by each of the programs will be described later in detail.

Further, the general controller 90 controls the operation of a stage driving device 80 for driving the moving stage 14, and the light source unit 16.

For example, a DRAM may be used as the first frame memory 82 and the second frame memory 84. However, it is not limited to this and an MRAM or an FRAM may be also used. Any memory which stored data can be read sequentially in a direction in which addresses continue may be used. Alternately, any memory which stored data can read by so-called burst transfer may be used.

The controller 20 detects each position of the exposure point of each of the exposure heads 26 based on the detection signal from each of the photosensors 72. The controller 20 calculates information on the position of the exposure point, such as an optical magnification, based on the detected each position of the exposure points, and outputs to the image data transformation unit 81 and the like.

Next, an operation for detecting a beam position using the detection slit 74 provided in the exposure device 10 will be described.

Firstly, an operation of the exposure device 10 to specify an actual position, on the exposure surface, that is irradiated by one particular lighted pixel Z1 which is a measured pixel, using the detection slit 74 will be described.

In this case, the general controller 90 moves the moving stage 14 to position the predetermined detection slit 74 for the predetermined exposure head 26 of the slit plate 70 below the exposure head unit 18.

Then, the general controller 90 controls only the particular pixel Z1 in the predetermined DMD 36 so as to be on state (lighting state).

Further, the general controller 90 controls the moving stage 14 to move so that the detection slit 74 positions at a predetermined position (e.g., a position to be an origin point) on the exposure area 32, as indicated by the solid line in FIG. 10A. The general controller 90 recognizes the position of the intersection of the first slit portion 74a and the second slit portion 74b as (X0, Y0) and stores the position in a memory. In FIG. 10A, a direction rotating in the counterclockwise direction from the Y axis provides a positive angle.

As shown in FIG. 10A, the general controller 90 controls the moving stage 14 to start moving the detection slit 74 toward right direction in FIG. 10A along the Y axis. The general controller 90 stops the moving stage 14 in a position indicated by an imaginary line at the right side in FIG. 10A when, as illustrated in FIG. 10B, the light from the lighting particular pixel Z1 passing through the first slit portion 74a is detected by the photosensor 72. The general controller 90 recognizes the position of intersection of the first slit portion 74a and the second slit portion 74b as (X0, Y11) and stores it in the memory.

Next, the general controller 90 operates the moving stage 14 to start moving the detection slit 74 to the left direction in FIG. 10A along the Y axis. The general controller 90 stops the moving stage 14 in a position indicated by an imaginary line at the left side in FIG. 10A when, as illustrated in FIG. 10B, the light from the lighting specified pixel Z1 passing through the first slit portion 74a is detected by the photosensor 72. The general controller 90 recognizes the position of the intersection of the first slit portion 74a and the second slit portion 74b as (X0, Y12) and stores it in the memory.

Then, the general controller 90 reads out the coordinates (X0, Y11) and (X0, Y12) stored in the memory to determine the coordinates of the particular pixel Z1 and performs computation by the following equation to determine the actual position. Here, when the coordinates of the particular pixel Z1 are (X1, Y1), X1=X0+(Y11−Y12)/2 and Y1=(Y11+Y12)/2.

As described above, when a combination of the detection slit 74 having the first slit portion 74a and the second slit portion 74b orthogonally intersecting and the photosensor 72 is used, the photosensor 72 detects only light in a predetermined range which passes through the first slit portion 74a or the second slit portion 74b. Therefore, there is no need to configure the photosensor 72 to have a minute and special configuration for detecting an amount of light only in a small range corresponding to the first slit portion 74a or the second slit portion 74b, and a commercially available low cost sensor may be used.

Next, an operation of the exposure device 10 for detecting the information on the position of the exposure point, such as the optical magnification, in the X axis direction and the Y axis direction, of the exposure area (entire surface exposure area) 32 which is capable of projecting an image on the exposure surface by one exposure head 26, the tilt of the exposure head 26 (the exposure area), and the amount of movement from the reference position of the exposure head 26 in the X axis direction and the Y axis direction.

In order to detect the information on the position of the exposure point of the exposure area 32 as the entire surface exposure area, as shown in FIG. 3, in the exposure device 10, the plural detection slits 74, five detection slits 74 in this embodiment, perform position detection with respect to one exposure area 32 at the same time.

Therefore, a plurality of measured pixels averagely distributed and scattered in the exposure area to be measured are set in one exposure area 32 of the exposure head 26. In this embodiment, five sets of measured pixels are set. The plural measured pixels are set to be symmetric with respect to the center of the exposure area 32. In the exposure area 32 shown in FIG. 8, with respect to a set (here, including three measured pixels) of measured pixels Zc1, Zc2, and Zc3 positioned in the center position in the longitudinal direction, two pair of sets of measured pixels, a pair of Za1, Za2, Za3 and Zb1, Zb2, Zb3, and a pair of Zd1, Zd2, Zd3 and Ze1, Ze2, Ze3 are set symmetrically.

Further, as shown in FIG. 8, five detection slits 74A, 74B, 74C, 74D, and 74E are arranged in the slit plate 70 in positions corresponding to each of the sets of measured pixels so as to detect each of the sets.

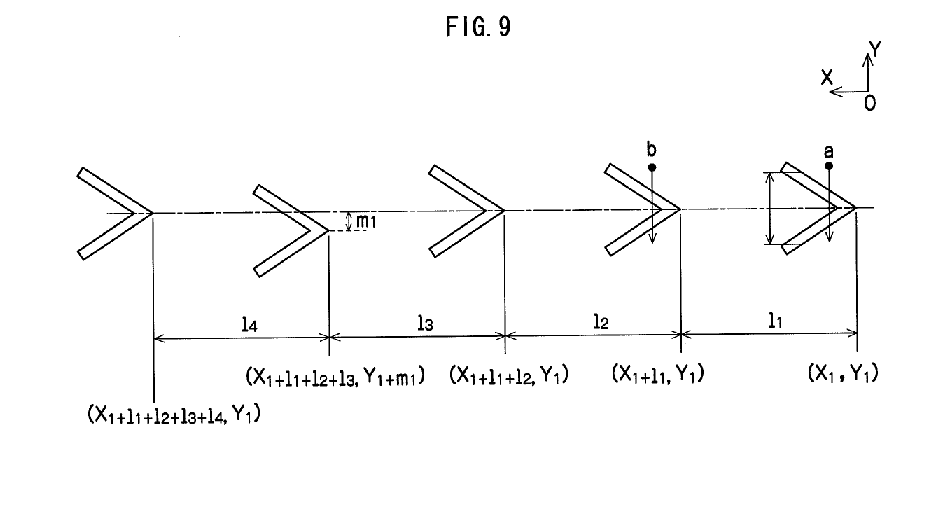

To facilitate computation for adjusting the processing error between the five detection slits 74A, 74B, 74C, 74D, and 74E formed in the slit plate 70, relations between the relative coordinate positions of the intersection of the first slit portion 74a and the second slit portion 74b are determined. In the slit plate 70 shown in FIG. 9, when the coordinates (X1, Y1) of the first detection slit 74A is set to be a reference, the coordinates of the second detection slit 74B are (X1+l1, Y1), the coordinates of the third detection slit 74C are (X1+l1+l2, Y1), the coordinates of the fourth detection slit 74D are (X1+l1+l2+l3, Y1+m1), and the coordinates of the fifth for detection slit 74E are (X1+l1+l2+l3+l4, Y1).

Based on the above-described condition, when the general controller 90 detects the information on the position of the exposure point of the exposure area 32, it controls the DMD 36 to set the measured pixels (Za1, Za2, Za3, Zb1, Zb2, Zb3, Zc1, Zc2, Zc3, Zd1, Zd2, Zd3, Ze1, Ze2, and Ze3) in the predetermined group into on state and moves the moving stage 14 provided with the slit plate 70 just below each of the exposure heads 26. Thereby, the coordinates of each of the measured pixels are determined using each of the detection slits 74A, 74B, 74C, 74D, and 74E corresponding to the measured pixels. In the measurement, each of the measured pixels in the predetermined group may be respectively set to be on state, or all measured pixels in the predetermined group may be set to be on state.

Based on the determined coordinates of each of the measured pixels, the optical magnification in the X axis direction and the Y axis direction, the tilt of the exposure head 26, and the amount of movement from the reference position of the exposure head 26 in the X axis direction and the Y axis direction are calculated and stored in the memory.

The optical magnification in the X axis direction can be determined by determining the distance between the X coordinates of the measured pixel Za1 and the measured pixel Zb1 in the X axis direction. However, the present invention is not limited to this, and the optical magnification in the X axis direction may be determined as an average value of the distances between the measured pixels in the same row in the X axis direction.

The optical magnification in the Y axis direction can be determined by determining the distance between the Y coordinates of the measured pixel Za1 and the measured pixel Za3 in the Y axis direction. However, the present invention is not limited to this, and the optical magnification in the Y axis direction may be determined as an average value of the distances between the measured pixels in the same column (the same set) in the Y axis direction.

The angle of tilt of the exposure head 26 can be determined based on the distance between the measured pixel Za1 and the measured pixel Za3 in the X axis direction and the Y axis direction, from the X coordinates and the Y coordinates of the measured pixel Za1 and the measured pixel Za3.

The amount of movement from the reference position of the exposure head 26 in the X axis direction and the Y axis direction can be determined by storing the reference position of each of the measured pixels in the memory, and determining the difference, in the X axis direction and the Y axis direction respectively, between the reference position of at least some measured pixels and the detected actual position of the some measured pixel.

In the above described exposure device 10, it is described that the plurality of detection slits 74A, 74B, 74C, 74D, and 74E are formed in the slit plate 70 and the photosensor 72 is provided corresponding to each of them. However, the present invention is not limited to this configuration, and a combination of a single detection slit 74 and a single photosensor 72 may be moved with respect to the moving stage 14 in the X axis direction to perform the position detection for each of the sets of the measured pixels.

### [Operation of the Image Forming Device]

An operation of the exposure device 10 configured as described above will be described.

Firstly, the image data outputting device 71, such as a computer, creates image data according to an image to be exposed (formed) on the photosensitive material 11. The image data is outputted to the exposure device 10 and inputted into the image data transformation unit 81.

The image data outputting device 71 outputs the image data as Gerber data (vector data) to the image data transformation unit 81. The image data transformation unit 81 converts the Gerber data to raster data.

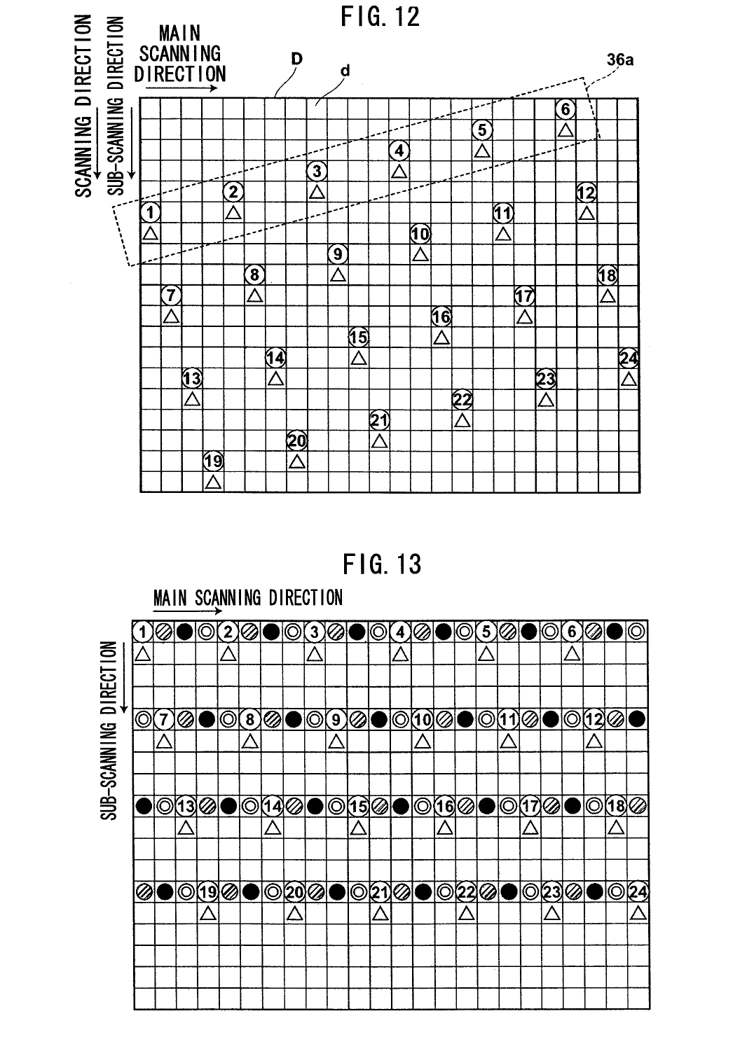

That is, the image data D converted by the image data transformation unit 81 is data which represents density of each pixel structuring the image by a binary value (a presence or absence of recording of dots). This means that, as shown in FIG. 12, a large number of pixel data d are arrayed in a two-dimensional manner in a main scanning direction and a sub-scanning direction which is orthogonal to the main scan direction.

Circled numbers 1 to 24 in FIG. 12 schematically show the micro mirrors 46 (the exposure positions) of the DMD 36. FIG. 12 shows the correspondence relation between each of the pixel data d of the image data D and each of the micro mirrors 46 into which the pixel data d is inputted.

Each grating in FIG. 12 indicates respective pixel data, as described above, and also indicates pixels forming the image exposed on the photosensitive material 11. As shown in FIG. 12, the image data D is created such that the conveying direction shown in FIG. 1 matches with the sub-scan direction. A triangle mark in FIG. 12 indicates a position of the micro mirror 46 when the DMD 36 is moved by one pixel in the scan direction. That is, one frame data is created by the pixel data d corresponding to the circled numbers 1 to 24 in FIG. 12, and the next frame data is created by the pixel data d corresponding to the triangle marks in FIG. 12. Incidentally, FIG. 12 shows a state in which the optical magnification, the tilt, and the position of the exposure head 26, and the like satisfy predetermined references without deviations, that is, an ideal state.

Here, the optical magnification, the tilt, and the position of the exposure head 26 may be change with time due to factors such as temperature change and vibration. Therefore, the exposure device 10 performs data processing to determine the optical magnification and the like by the above method in a predetermined period and transform and rearrange the image data based on the determined optical magnification and the like so as to appropriately expose the image data. That is, the deviation of the optical magnification and the like due to change with time and/or a mounting error of the exposure head 26 are eliminated by transforming and rearranging the image data, without mechanically adjusting the exposure head 26.

Firstly, the image data transformation unit 81 determines an imaging resolution in the X axis direction (the main scan direction) based on the optical magnification in the X axis direction determined by the general controller 90. This imaging resolution R1 can be determined by the following equation, where an ideal resolution (design value) is R0, the optical magnification in the X axis direction determined by detecting the actual position of the exposure point is A1, and an ideal optical magnification (design value) in the X axis direction is A0.

R1=R0×(A1/A0) (1)

The inputted image data is resolution converted based on this imaging resolution. Specifically, the inputted Gerber data is converted to raster data that is an integral multiple of the imaging resolution. For example, when the imaging resolution (a pitch between the exposure dots in the X axis direction) is determined to be 1.01 μm, the Gerber data is converted to the raster data so that the resolution of the image data will be 2.02 μm which is double the imaging resolution.

Thereby, even when the optical magnification is deviated from the reference, that is, the design value, in the X axis direction, the position of the exposure point and each of the pixel positions of the image data can be matched with each other. That is, the exposure positions of the circled numbers 1 to 24 in FIG. 12 can be matched with the gratings.

As described above, the array direction of a micro mirror line 36a is inclined with respect to the scan direction of the DMD (the sub-scan direction of the image data D). Therefore, if the frame data is created, i.e., the pixel data d corresponding to each of the micro mirrors 46 is collected from the image data created in the above manner, it takes long time to read the pixel data from the memory storing the image data, and the creation time of the frame data becomes longer.

In the exposure device 10 of this embodiment, the image data is subjected to the transformation processing by the image data transformation unit 81. Specifically, as shown in FIG. 13, the image data is subjected to the transformation processing so that the array direction of the pixel data corresponding to each of the micro mirrors 46 matches with the main scanning direction. The transformation processing can be performed by, for example, shifting the pixel data corresponding to each of the micro mirrors 46 in a direction opposite to the sub-scanning direction shown in FIG. 13.

Then, the transformed image data transformed in the above manner is outputted from the image data transformation unit 81 and stored in the first frame memory 82. At this time, the transformed image data is stored in a manner such that the direction in which the addresses in the first frame memory 82 are continuous and the array direction in which the pixel data arrays in the main scanning direction are matched with each other.

Next, the transformed image data stored in the first frame memory 82 is subjected to the rearrangement processing by the pixel data rearrangement unit 83. Specifically, the pixel data belonging to the same frame data is collected by selecting and collecting one by one, from the pixel data arrayed in the main scanning direction in the transformed image data as shown in FIG. 13, the pixel data positioned so as to correspond to one pixel data per every predetermined number of the pixel data. The collected pixel data is processed in such manner that the collected pixel data is successively arranged. At this time, the pixel data is collected at a pixel pitch according to the calculated imaging resolution, and the pixel data at the position according to the amount of movement (deviation) from the reference position in the X axis direction determined by the general controller 90 is collected. That is, the pixel data is collected so as to eliminate (correct) the deviation of the pixel position in the X axis direction due to the deviation of the exposure head 26 from the reference position in the X axis direction.

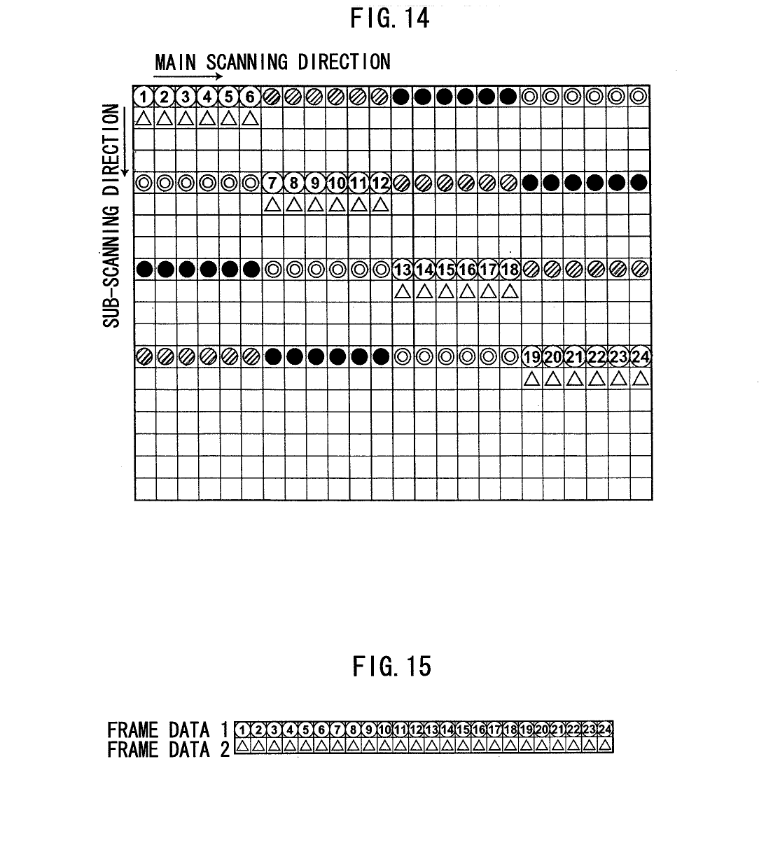

By performing the above-described processing sequentially from the leftmost pixel data of the pixel data arrayed in the main scanning direction, the transformed image data shown in FIG. 13 is processed to be the rearrangement-processed image data as shown in FIG. 14. That is, the rearrangement processing is performed to the transformed image data in so that the pixel data belonging to the same frame data are successively arrayed in the main scanning direction. The above rearrangement processing may be performed by a program or hardware. FIGS. 13 and 14 show the transformed image data and the rearrangement-processed image data based on the image data in an ideal state as shown in FIG. 12.

The rearrangement-processed image data having the pixel data arranged as shown in FIG. 14 is stored in the second frame memory 84. At this time, the rearrangement-processed image data is stored in such a manner that the direction in which the addresses are continuous in the second frame memory 84 matches with the array direction in which the pixel data arrayed in the main scanning direction are matched with each other.

Then, the frame data creation unit 85 creates frame data based on the rearrangement-processed image data stored in the second frame memory 84 as described above. Specifically, the frame data creation unit 85 creates frame data 1 as shown in FIG. 15 by selecting and collecting the pixel data belonging to the same frame data in the rearrangement-processed image data shown in FIG. 14, e.g., the pixel data corresponding to the micro mirrors 46 of the circled numbers 1 to 24. Then, the frame data creation unit 85 creates frame data 2 as shown in FIG. 15 by selecting and collecting the pixel data corresponding to the triangle mark in FIG. 14. By repeating the above processing, the frame data creation unit 85 creates all of the frame data based on the image data D. Incidentally, FIG. 15 shows the frame data created from in the ideal state of data as shown in FIG. 12.

Here, the pixel data is collected by determining the reading positions of the pixel data in the Y axis direction according to the optical magnification in the Y axis direction (sub-scanning direction), the angle of tilt of the exposure head 26, and the amount of movement from the reference position in the Y axis direction, which are determined by the general controller 90. Namely, the pixel data is collected so as to eliminate (correct) the deviation of the optical magnification in the Y axis direction, the deviation of the angle of tilt of the exposure head 26, and the deviation of the pixel position in the Y axis direction due to the deviation from the reference position in the Y axis direction.

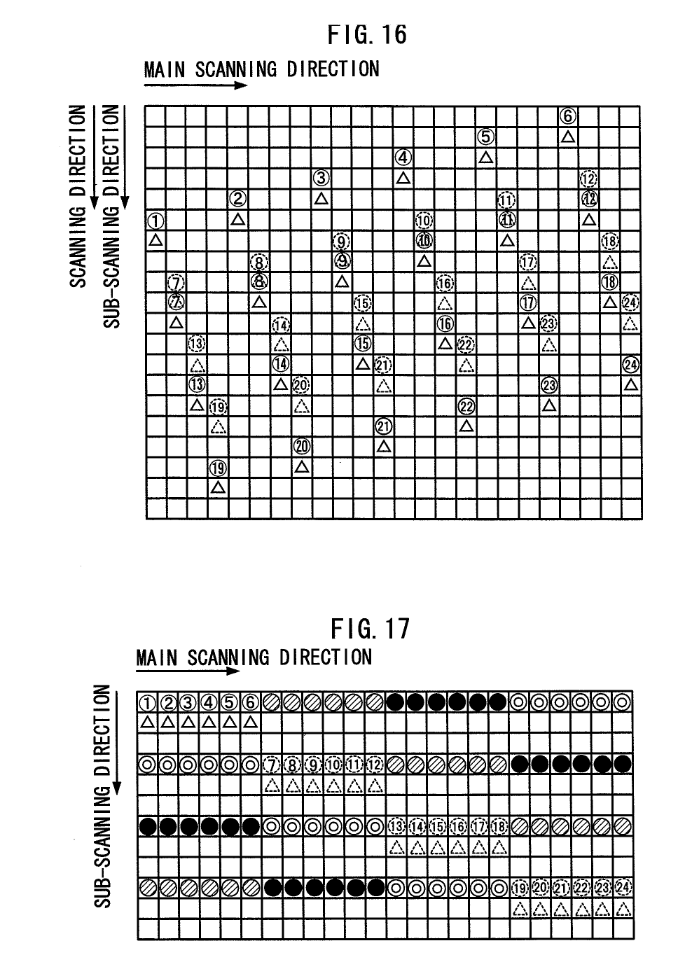

For example, a case where the exposure dots are deviated from the ideal state shown in FIG. 12 to dotted circled numbers 1 to 24 indicated in FIG. 16, i.e., the positions indicated by the dotted triangles, that is, a case where the magnification in the Y axis direction is smaller by one line will be described. In this case, instead of collecting the pixel data in every fourth lines when there is no position deviation as shown in FIG. 13, the pixel data is collected in every third lines as shown in FIG. 17. Thereby the magnification in the Y axis direction can be corrected. When number of lines corresponding to the deviation of the magnification in the Y axis direction is not an integer, for example, the pixel data can be appropriately collected in every fourth lines, as needed, rather than in every third lines, so that the number of lines may change as occasion requires. Thereby, fine adjustment of the magnification correction may be performed.

The frame data creation unit 85 sequentially outputs the frame data created as above to the DMD controller 66. The DMD controller 66 generates a control signal according to the inputted frame data. The frame data as described above is created for the DMD 36 of each of the exposure heads 26 to generate the control signal for each of the DMDs 36.

Thus, the control signal for each of the exposure heads 26 is generated and a stage driving control signal is outputted from the general controller 90 to the stage driving device 80. The stage driving device 80 moves the moving stage 14 along the guides 30 at a desired speed in the stage moving direction according to the stage driving control signal. When the moving stage 14 passes below the gate 22 and the edge of the photosensitive material 11 is detected by the position detection sensors 24 mounted on the gate 22, the control signal is outputted from the DMD controller 66 to the DMD 36 of each of the exposure heads 26 to start imaging by each of the exposure heads 26.

The photosensitive material 11 is moved at a constant speed together with the moving stage 14, the photosensitive material 11 is scanned in the opposite direction of the stage moving direction by the exposure head unit 18, and thereby a band-shaped exposed area 34 is formed for each of the exposure heads 26.

When the scanning of the photosensitive material 11 by the exposure head unit 18 is completed and the rear edge of the photosensitive material 11 is detected by the position detection sensors 24 as described above, the moving stage 14 returns to the origin point at the uppermost stream side of the gate 22 along the guides 30 by the stage driving device 80. After a new photosensitive material 11 is placed, the moving stage 14 moves again at a constant speed from the upstream side to the downstream side of the gate 22 along the guides 30.

Thus, in this embodiment, the deviations of the optical magnification, the angle of tilt, and the position from the reference position of the exposure head 26 are calculated based on the detected exposure point position, resolution conversion, transformation, and rearrangement of the image data are performed based thereon, and a data processing is performed to the image data so as to eliminate the deviation of the pixel position due to these deviations. Accordingly, even if the optical magnification, the tilt, and the position of the exposure head 26 are changed with time due to the factors such as temperature change and vibration, good image quality can be maintained. Further, a complicated adjustment mechanism for adjusting the optical magnification and so on is unnecessary, and therefore the adjustment of the deviation of the pixel position can be automated and the frame data creation device can be configured at low cost.

In the exposure device 10 according to the present embodiment, the DMD is used as the spatial light modulator used for the exposure head 26. However, it is not limited to this configuration and a MEMS (Micro Electro Mechanical Systems) type spatial light modulator (SLM) or a spatial light modulation element which is not MEMS type, such as an optical element (PLZT element) that modulates a transmission light by electro optical effect or a liquid crystal light shutter (FLC) can be used instead of the DMD.

Here, MEMS generally refers to a micro system in which a micro-sized sensor, actuator, and control circuit are integrated by a micromachining technique based on an IC manufacturing process. A MEMS type spatial light modulator refers to a spatial light modulator driven by an electro mechanical operation using electric static force.

Further, in the exposure device 10 according to the present embodiment, the spatial light modulator (DMD) 14 used for the exposure head 26 may be replaced with a device that selectively turns on and off of the plurality of pixels. This device may be configured by a laser light source which can emit a laser beam by selectively turning on and off of the laser beam corresponding to each pixel, or by a laser light source which forms a surface emitting laser element by arranging each of micro laser emitting surfaces corresponding to each of the pixels and selectively turns on and off of the micro laser emitting surface to emit the laser beam.

In the above embodiment, the exposure device of so-called flat bed type is described as an example. However, the exposure device may be so-called outer drum type having a drum with a photosensitive material wound therearound.

The photosensitive material 11 to be exposed in the above embodiment may be a printed circuit board or a filter for a display. The shape of the photosensitive material 11 may be a sheet-like or a long (flexible substrate) material.

The imaging method and device according to the invention is applicable to an imaging control in an ink-jet printer or the like. For example, an imaging dot formed by ink discharging may be controlled by the same method as the present invention. Accordingly, the imaging element according to the present invention may be considered to be replaced with an element for marking an imaging dot by an ink discharging.

### DESCRIPTION OF REFERENCE NUMERALS

10 Exposure device
11 Photosensitive material
14 Moving stage
16 Light source unit
18 Exposure head unit
20 Controller
26 Exposure head
36 DMD (imaging dot formation unit)
46 Micro mirror (imaging element)
70 Slit plate
72 Photosensor (imaging dot position detection unit)
74 Detection Slit
80 Stage driving device
81 Image data transformation unit (image data transformation unit, storage controller)
82 First frame memory (storage unit)
83 Pixel data rearrangement unit (pixel data rearrangement unit)
84 Second frame memory
85 Frame data creation unit (frame data creation unit)
90 General controller (imaging dot position detection unit, calculation unit)

1. A frame data creation device that creates frame data used for forming an image having a plurality of imaging dots arranged two-dimensionally on an imaging surface, in which the image is formed by moving, with respect to the imaging surface, an imaging dot formation unit having a plurality of imaging element groups arrayed in parallel, in a scanning direction forming a predetermined angle of θ(0°<θ<90°) with an array direction of the imaging element group, and by sequentially inputting the frame data comprising data of the plurality of imaging dots corresponding to the imaging elements into the imaging dot formation unit during the movement in the scanning direction to sequentially form an imaging dot group in chronological order, wherein the imaging element group includes a plurality of imaging elements, which form the imaging dots on the imaging surface, arranged in a line, and the frame data creation device obtains the plurality of imaging dots data based on image data according to the image in which pixel data corresponding to the imaging dots data is arranged two-dimensionally in a sub-scanning direction corresponding to the scanning direction and a main scanning direction that is orthogonal to the sub-scanning direction, so as to create the frame data, the frame data creation device comprising:
an imaging dot position detection unit that detects each of the positions of the imaging dots to be formed by at least some of the imaging elements of the imaging element group; and
a frame data creation unit that creates the frame data so as to correct a deviation of the pixel position due to a deviation of the position of the imaging dot, based on the detected position of each of the imaging dots.

2. The frame data creation device of claim 1, further comprising a calculation unit that calculates at least one of an optical magnification of the imaging element group in a predetermined direction, a tilt thereof, or an amount of movement from a predetermined reference position, based on the detected position of each of the imaging dots,
wherein the frame data creation unit creates the frame data so as to correct a deviation of the pixel position due to a deviation of the position of the imaging dot, based on the calculation value of the calculation unit.

3. The frame data creation device of claim 2, wherein the calculation unit calculates a resolution in the main scanning direction, and
the frame data creation unit converts the image data according to the resolution and creates the frame data based on the converted image data.

4. The frame data creation device of claim 3, wherein the frame data creation unit converts the image data so as to have a resolution of an integral multiple of the resolution.

5. The frame data creation device of claim 2, further comprising an image data transformation unit that performs a transformation processing to the image data according to the tilt of the imaging element group so that the pixel data in the image data corresponding to the imaging element group are arrayed in the main scanning direction,
wherein the frame data creation unit obtains the plurality of imaging dots data based on the transformed image data to create the frame data.

6. The frame data creation device of claim 5, further comprising:
a storage unit that stores the transformed image data; and
a storage controller that stores the pixel data in a manner such that an array direction of the pixel data corresponding to the imaging element group matches with a direction in which addresses of the storage unit are continuous,
wherein the frame data creation unit reads the pixel data stored in the storage unit from the storage unit to obtain the plurality of imaging dots data.

7. The frame data creation device of claim 5, wherein the image data transformation unit performs the transformation processing by shifting each of the pixel data corresponding to the imaging element group in the sub-scanning direction according to the calculation value.

8. The frame data creation device of claim 2, further comprising a pixel data rearrangement unit that rearranges the pixel data in the scanning direction in a manner such that the pixel data belonging to the same frame data corresponding to each of the imaging elements of the imaging element group is arranged successively in the main scanning direction,
wherein the frame data creation unit creates the frame data based on the image data rearranged by the pixel data rearrangement unit so as to correct a deviation of the pixel position due to a deviation of the position of the imaging dot in the scanning direction based on the calculation value.

9. The frame data creation device of claim 1, wherein the imaging element comprises a micro mirror, and
the imaging dot formation unit comprises an exposure unit that exposes an imaging image onto an exposure surface by modulating light emitted from a light source by the micro mirror.

10. A frame data creation method that creates frame data used for forming an image having a plurality of imaging dots arranged two-dimensionally on an imaging surface, in which the image is formed by moving, with respect to the imaging surface, an imaging dot formation unit having a plurality of imaging element groups arrayed in parallel, in a scanning direction forming a predetermined angle of θ (0°<θ<90°) with an array direction of the imaging element group, and by sequentially inputting the frame data comprising data of a plurality of imaging dots corresponding to the imaging elements into the imaging dot formation unit according to the movement in the scanning direction to sequentially form the imaging dot group in chronological order, wherein the imaging element group includes a plurality of imaging elements, which form the imaging dots on the imaging surface arranged in a line, and the method obtains the plurality of imaging dots data based on image data according to the image in which pixel data corresponding to the imaging dot data is arranged two-dimensionally in a sub-scanning direction corresponding to the scanning direction and a main scanning direction orthogonal to the sub-scanning direction, so as to create the frame data, the frame data creation method comprising:
detecting each of positions of the imaging dots to be formed by at least some of the imaging elements of the imaging element group; and
creating the frame data so as to correct a deviation of the pixel position due to a deviation of the position of the imaging dot based on the position of each of the detected imaging dots.

11. The frame data creation method of claim 10, further comprising calculating at least one of an optical magnification of the imaging element group in a predetermined direction, a tilt thereof, or an amount of movement from a predetermined reference position based on the position of each of the detected imaging dots.

12. The frame data creation method of claim 11, wherein the calculation comprises calculating a resolution in the main scanning direction, and
the frame data creation comprises converting the image data according to the resolution and creating the frame data based on the converted image data.

13. The frame data creation method of claim 12, wherein the frame data creation comprises converting the image data so as to have a resolution of an integral multiple of the resolution.

14. The frame data creation method of claim 11, further comprising performing transformation processing to the image data according to the tilt of the imaging element group in a manner such that the pixel data in the image data corresponding to the imaging element group are arrayed in the main scanning direction,
wherein the frame data creation comprises obtaining the plurality of imaging dots data based on the transformed image data to create the frame data.

15. The frame data creation method of claim 14, further comprising:
storing the transformed image data in a storage unit; and
controlling to store the pixel data in a manner such that an array direction of the pixel data corresponding to the imaging element group matches with a direction in which addresses of the storage unit are continuous,
wherein the frame data creation comprises reading out the stored pixel data to obtain the plurality of imaging dots data.

16. The frame data creation method of claim 14, wherein the transformation processing comprises performing the transformation processing by shifting each of the pixel data corresponding to the imaging element group in the sub-scanning direction according to the calculation value.

17. The frame data creation method of claim 11, further comprising rearranging the pixel data in the scanning direction in a manner such that the pixel data belonging to the same frame data corresponding to each of the imaging elements of the imaging element group is arranged successively in the main scanning direction,
wherein the frame data creation comprises creating the frame data based on the rearranged image data to correct a deviation of the pixel position due to a deviation of the position of the imaging dot in the scanning direction based on the calculation value.

18. (canceled)

19. A storage medium that stores a frame data creation program that performs in a computer a procedure for creating frame data used for forming an image having a plurality of imaging dots arranged two-dimensionally on an imaging surface, in which the image is formed by moving, with respect to the imaging surface, an imaging dot formation unit having a plurality of imaging element groups arrayed in parallel, in a scanning direction forming a predetermined angle of θ (0°<θ<90°) with an array direction of the imaging element group, and by sequentially inputting the frame data comprising data of a plurality of imaging dots corresponding to the imaging elements into the imaging dot formation unit during the movement in the scanning direction to sequentially form the imaging dot group in chronological order, wherein the imaging element group includes a plurality of imaging elements forming the imaging dots on the imaging surface arranged in a line, and the frame data creation program causes the computer to perform a processing to obtain the plurality of imaging dot data based on image data according to the image in which pixel data corresponding to the imaging dot data is arranged two-dimensionally in a sub-scanning direction corresponding to the scanning direction and a main scanning direction orthogonal to the sub-scanning direction so as to create the frame data, the processing comprising:
detecting each of the positions of the imaging dots to be formed by at least some imaging elements of the imaging element group; and
creating the frame data so as to correct a deviation of the pixel position due to a deviation of the position of the imaging dot based on the position of each of the detected imaging dots.

20. An image imaging device comprising:
a frame data creation device of claim 1;
the imaging dot formation unit that forms the imaging dot group having the plurality of imaging dots on the imaging surface based on the inputted frame data;
a movement unit that moves the imaging dot formation unit with respect to the imaging surface in the scanning direction; and
an image formation controller that sequentially inputs the frame data created by the frame data creation device into the imaging dot formation unit during the movement by the movement unit in the scanning direction to sequentially form the imaging dot group by the imaging dot formation unit in chronological order, and forming an image having the plurality of imaging dots arranged two-dimensionally on the imaging surface.
